(19) United States
(12) Patent Application Publication
(10) Pub. No.: US 2021/0245040 A1
(43) Pub. Date: Aug. 12, 2021

(54) Theda's Learning Series

(71) Applicant: Theda Eugenia, Rialto, CA (US)

(72) Inventor: Theda Eugenia, Rialto, CA (US)

(21) Appl. No.: 16/786,776

(22) Filed: Feb. 10, 2020

(51) Int. Cl. A63F 9/34; G09B 19/00; G09B 1/38

(52) U.S. Cl. CPC A63F 9/34; G09B 1/38; G09B 19/00

(57) ABSTRACT

This invention is unique because it appeals to all of the learning types. It is tactile and didactic giving players a social emotion opportunity to interact with one another while learning. We are constantly given new information to learn however the opportunity to practice using or new information is limited to standard forms such as answering questions and writing answers. This approach improves the chance for retaining the information learned. The self produced storybook or journal gives the player a self produced learning tool created in their own unique way increasing the chance of their reusing the tool to practice. This tool deepens their understanding of the information and their ability to retain the information.

### CROSS REFERENCE TO RELATED APPLICATIONS

There are no other applications.

### STATEMENT REGARDING FEDERALLY SPONSORED RESEARCH

There are no federally sponsored research projects.

### NAMES OF PARTIES TO A JOINT RESEARCH AGREEMENT

There is only one inventor. Theda Eugenia

### REFERENCE TO SEQUENCE LISTING

This patent has no technology application.

### STATEMENT REGARDING PRIOR DISCLOSURE BY THE INVENTOR

This learning series is the result of my sharing the way that I stayed attentive to my school work. I shared my method with young children while volunteering for preschoolers they settled down to participate which prompted me to use it for other students as needed. Prior to seeking the help of professionals I had identified a need and or problem that prompted me into the invention process during the 1970's. While volunteering for the preschool project in Philadelphia Pa. I was given the opportunity to work with young students who also settled down when given the opportunity to use my game. I began learning about what the series should consist of and created a prototype. I used this prototype as a Preschool Teacher and also as an Elementary teacher, 1992-2000. Drawings and a written description were prepared for review byl-InventHelp 2007. No attempts have been made to manufacture or market Theda's Learning Series Game.

### BACKGROUND OF INVENTION

### Historical Background

Theda's learning series is for the Field of Education. I began creating this game as a young child who enjoyed playing more than sitting still reading. I learn through motion much easier than being able to retain information that I read. As a result of spending countless hours alone attempting to understand and retain information I found it much easier to work with my hands pulling the words from piles and connecting them back to the text. My pencil was the hook and my words or numbers were the fish. By the time I was in high school my system was very popular to the point of my receiving recognition as being a young inventor at my high school assemblies.

### BRIEF SUMMARY OF THE INVENTION

The concept of Theda's Learning Series Game is to be an entertaining and educational game that would help players learn and retain what they have learned about letters, colors, numbers and concepts.

### BRIEF DESCRIPTION OF THE SEVERAL VIEWS OF THE DRAWINGS

37 CFR 1.77 (b) (9), 1.84 and 1.121(d)

“Replacement Sheet”

FIG. 1 of 4

FIG. 1 THE FRONT VIEW OF THE FISH MANIPULATIVE

FIG. 1 The fish manipulative is the main piece for Theda's Learning Series. For each activity this fish will be labeled according to the game being played. Once hooked the player uses the fish piece to achieve the task requirement. If we are doing number counting and recognition the group can work on building a number line of the number as they are hooked. A—an opening to place the label, B— magnetic eye to hook fish, C—magnetic strip to catch fish.

“Replacement Sheet”

FIG. 2 of 4

FIG. 2 THE BACK VIEW OF THE FISH MANIPULATIVE

This view shows the back view of the main manipulative shown in FIG. 1 The fish manipulative is the main piece for Theda's Learning Series. For each activity this fish will be labeled according to the game being played. Once hooked the player uses the fish piece to achieve the task requirement. If we are doing number counting and recognition the group can work on building a number line of the number as they are hooked. A—an opening to place the label, B—magnetic eye to hook fish, C—magnetic strip to catch fish.

“Replacement Sheet”

FIG. 3 of 4

FIG. 3 FRONT VIEW OF THE FISH MANIPULATIVE

FIG. 3 is the fishing hook. Players manipulate the hook in order to capture a fish to use to fulfill the requirements of the activity being played. The magnet of the hook has to come in contact with either or both magnets on the fish a manipulative in order to be pulled up and away from the school of fish. When this occurs the player has captured a fish manipulative and can then proceed to fulfilling the activity requirement. A—is a magnet attached to the cord of the pole. B—is the cord that extends into the fish selection and C—is the players hold while attempting to catch a fish.

“Replacement Sheet”

FIG. 4 of 4

FIG. 4 BACK VIEW OF THE FISH HOOK MANIPULATIVE

FIG. 4 is the back vie of the fishing hook. Players manipulate the hook in order to capture a fish to use to fulfill the requirements of the activity being played. The magnet of the hook has to come in contact with either or both magnets on the fish a manipulative in order to be pulled up and away from the school of fish. When this occurs the player has captured a fish manipulative and can then proceed to fulfilling the activity requirement. A—is a magnet attached to the cord of the pole. B—is the cord that extends into the fish selection and C—is the players hold while attempting to catch a fish.

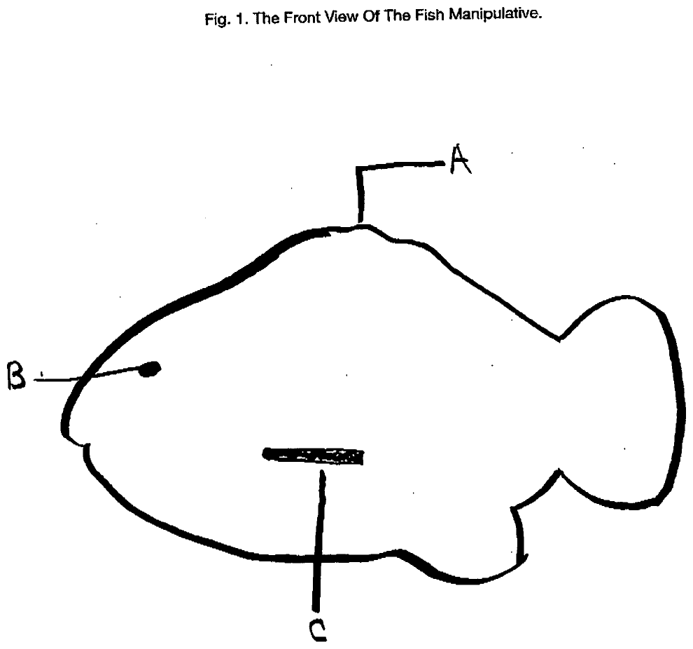

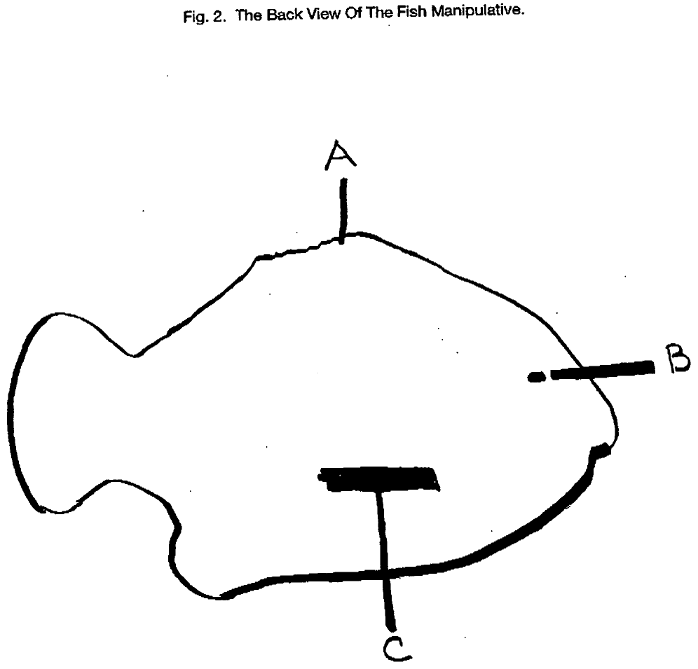

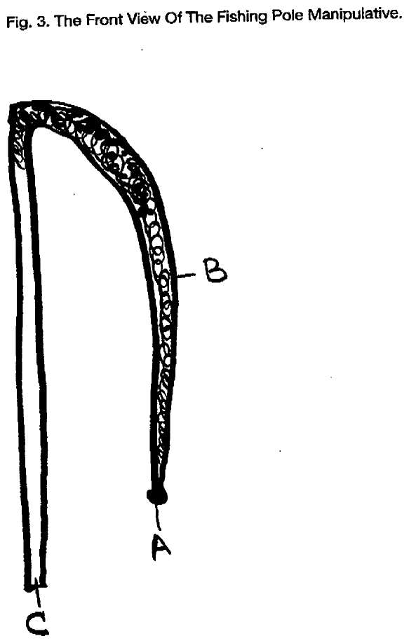

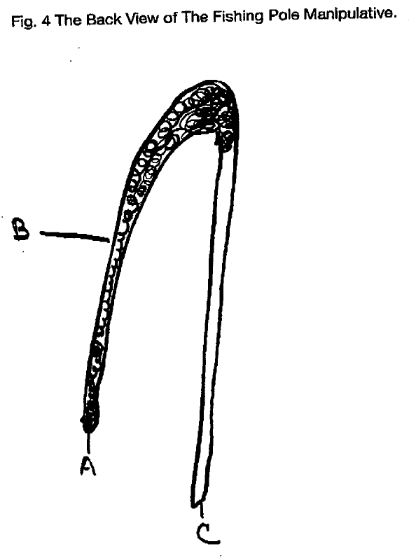

### 10. DETAILED DESCRIPTION OF THE INVENTION

The concept of Theda's Learning Series Game is to be an entertaining and educational game that would help players learn and retain what they have learned about letters, colors, numbers and concepts. When manufactured it would consist of a series of plastic rods and fish shaped pieces. Each rod would be s simple device that would have a fishing line and attached magnet.

The fish could be imprinted with with various words, shapes, numbers, letters and concepts in an array of colors. Each fish would also have a magnet. To play the players would take turns using the rod to ‘catch’ a fish. When a player pulls out a fish, he must correctly identify the word type, letter, shape, color, or number to keep the fish and score. Players would also form sentences using the words. The inventor suggest that the game could include a storybook featuring the objects and words used in the game. This book can be made by the player. The guide that goes with the activities is assigned or used as selected.

There are numerous ways to play the games in this series, as an Elementary School Teacher I assign lessons that a group of students who need practice using a specific skill can practice during our center time. For a kindergarten group during center for example they could: practice the abc's by hooking fish and saying the name of the letter to there group, I add the letter sound as needed. They get to keep the fish if they are correct. A tally is kept and rewards are earned for the number of fish a child has at the end of each round. I also use these games one to one with students and student groups.

Another game is mathematical. Suppose students are having difficulty with subtraction. Hooking numbered fish and building a subtraction problem with a buddy allows the child to better understand the idea that you are taking from a larger number. This practice is kept in the students math journal. When I am working with students my goal is for the students to analyze and be able to synthesize the idea.

### Variations

Theda's Learning Series is used for practice and review for several subjects. It is producible in a variety of materials and could be designed in travel and edible versions.

### Produce Ability

To date I have made it using construction paper cut outs and plastic material with stuffing. My colleagues have also made it using paper cut outs. If produced it would be more durable and require less remaking of the pieces.

### Functions and Appealing Features

One function would be its ability to be used to teach the players about colors, shapes, words and numbers through interactive play. These versatile games allow players of a wide age range to interact and have hours of fun and learning. Hooking and managing to identify the items on the fish gives the players a sense of accomplishment and provides an educational, yet entertaining pastime.

The use of fun games is much more effective than a simple oral question and answer process. The players would enjoy the process and would therefore better retain the facts learned. In addition to being used in the home, a game such as this has appeal to schools using educational games for students. This tool satisfies the requirements for a project based school environment.

1. The claim of Theda's Learning Series is that each activity is designed to entertain, teach, refine and practice to give the players knowledge in order to better retain the skill adding to their prior knowledge and to their schema. Playing the activities help the player to utilize their their knowledge in order to understand concepts more completely. As an educational game it helps players learn about letters, colors, shapes, numbers and concepts. As a entertaining activity it challenges players to capture a fish from the group fine tuning their fine motor skill.

2. As an educational game it helps players learn about colors, shapes, numbers and concepts. As an entertaining activity it challenges players ability to capture an object from a group.
